(19) United States
(12) Patent Application Publication
(10) Pub. No.: US 2026/0029283 A1
(43) Pub. Date: Jan. 29, 2026

(54) Circuit Optimization Method and System for Digital Domain Correction of Temperature Sensor

(71) Applicant: SENSYLINK MICROELECTRONICS INC., Shanghai (CN)

(72) Inventor: Zhi ZHOU, Shanghai (CN)

(73) Assignee: SENSYLINK MICROELECTRONICS INC., Shanghai (CN)

(21) Appl. No.: 18/833,421

(22) PCT Filed: Jun. 3, 2024
(86) PCT No.: PCT/CN2024/097001

§ 371 Date: Jul. 26, 2024

(30) Foreign Application Priority Data
Sep. 27, 2023 (CN) 202311269261.9

(51) Int. Cl. G01K 15/00; G01K 7/34

(52) U.S. Cl. CPC G01K 15/005; G01K 7/34

(57) ABSTRACT

A circuit optimization method and system for a digital domain correction of a temperature sensor is provided. The method includes: subjecting negative temperature coefficient voltages Vbep and Vben to a switch timing control, thereby generating a corresponding negative temperature coefficient voltage Vbep and positive temperature coefficient voltage Dvbe as inputs into an operational transconductance amplifier (OTA) that serves as a core circuit of a Sigam-Delt analog-to-digital converter (ADC); and generating, by a switch sampling circuit, Vintx by integrating; inputting the Vintx into a comparator (CMP) to acquire a final ADC output; and sending a feedback through a digital domain to an analog domain control switch logic. The circuit optimization method intelligently finds the optimal temperature factor of different processes through the digital domain correction, thereby acquiring the desired ratio value more accurately. Meanwhile, the circuit optimization method reduces the trim circuit to be implemented in the analog domain.

### CROSS REFERENCE TO THE RELATED APPLICATIONS

This application is the national phase entry of International Application No. PCT/CN2024/097001, filed on Jun. 3, 2024, which is based upon and claims priority to Chinese Patent Application No. 202311269261.9, filed on Sep. 27, 2023, the entire contents of which are incorporated herein by reference.

### TECHNICAL FIELD

The present disclosure relates to the technical field of electronic circuits, and in particular to a circuit optimization method and system for a digital domain correction of a temperature sensor.

### BACKGROUND

Temperature sensor chips are widely used in different scenarios in daily life, including various electronic products, mobile phones, servers, infrared thermometers, air conditioners, medical equipment, etc. Different application scenarios have different requirements for temperature accuracy, and high-accuracy application scenarios require high-accuracy optimization techniques to achieve high-accuracy temperature sensing. To achieve the continuously improving high-accuracy requirements, it is necessary to propose and implement more high-accuracy techniques.

As shown in FIG. 1, a traditional temperature sensor combines A*Dvbe with a digital domain control output cycle to generate VREF, such that there is a positive correlation between a ratio of A*Dvbe to VREF and temperature, thereby finally acquiring an output temperature through a conversion. The factor of A is generally achieved by a switch capacitance or resistance ratio in an analog domain. A trim capacitor has a relatively small unit capacitance, but the small capacitance per unit area may result in a significant mismatch. In addition, there are also problems such as nonlinear errors caused by the limited gain of the operational amplifier itself, accuracy problem caused by setup time and hold time, and leakage of the charge sharing switch.

Patent CN115514366A (Application Number CN202211420962.3) discloses a timing control optimization method for a single-to-double driver circuit in a temperature sensor, belonging to the technical field of electric power designs of temperature sensors. In this disclosure, a temperature sensor chip includes: a temperature to single-ended voltage circuit, configured to convert a temperature detected by the temperature sensor into a single-ended voltage; a single-to-double driver circuit, connected to the temperature to single-ended voltage circuit, and configured to convert the single-ended voltage to a double-ended voltage; an analog-to-digital converter (ADC) circuit, connected to the single-to-double driver circuit, and configured to convert a voltage signal into a digital signal; and a low dropout (LDO) circuit, connected to the ADC circuit, and configured to supply power to the ADC circuit. However, this patent cannot solve the current technical problems.

### SUMMARY

In view of the defects in the prior art, an objective of the present disclosure is to provide a circuit optimization method and system for a digital domain correction of a temperature sensor.

In the present disclosure, the circuit optimization method for a digital domain correction of a temperature sensor includes:
step 1: subjecting negative temperature coefficient voltages Vbep and Vben to a switch timing control, thereby generating a corresponding negative temperature coefficient voltage Vbep and positive temperature coefficient voltage Dvbe as inputs into an operational transconductance amplifier (OTA) that serves as a core circuit of a Sigam-Delt analog-to-digital converter (ADC); and
step 2: generating, by a switch sampling circuit, Vintx by integrating; inputting the Vintx into a comparator (CMP) to acquire a final ADC output; and sending a feedback through a digital domain to an analog domain control switch logic.

Preferably, Dvbe and a temperature derivative of Dvbe are relatively small, requiring multi-cycle conversions, or one conversion through a high capacitance ratio; and therefore, a T0 cycle is defined as a conversion cycle of Vbe, T0=1, while T1 is defined as a conversion cycle of Dvbe, T1≥1, and T0+T1=U; and
a ratio relationship between Vbe and Dvbe depends on an actual process; a temperature conversion requires U complete cycles to be superimposed to generate VREF; a ratio of Dvbe to Vbep generated through a digital control is equivalent to an OTA input, and an output proportional to Vbep is given to the OTA; and finally, through digital domain processing, an output digital temperature Dout is acquired.

Preferably, a proportional to absolute temperature (PTAT) current I0 is generated through a Bandgap circuit; the PTAT current is mirrored through Mp0 onto Mp1 and Mp2, with a quantitative ratio of Mp0:Mp1:Mp2=1:1:N; and therefore, a three-way current ratio is 1:1:N, and a ratio of currents passing through transistors Q0 and Q1 is 1:N;
based on the quantitative ratio of Q0 and Q1 being 1, the negative temperature coefficient voltages Vbep and Vben are acquired; Vbep is amplified by a switch logic and superimposed with Vben to generate the temperature independent reference voltage VREF, as shown in Eq. (1):

$$VREF = A * Vbep + Vben \qquad ( 1 )$$

meanwhile, the PTAT voltage DVbe is generated, as shown in Eq. (2):

$$DVbe = Vbep - Vben = \frac{KT}{q} ln ( N ) \qquad ( 2 )$$

where, Vbep and Vben are expressed by Eqs. (3) and (4), respectively:

$$Vbep = \frac{K T}{q} ln ( \frac{N * I 0}{I s} ) \qquad ( 3 )$$

$$Vben = \frac{K T}{q} ln ( \frac{I 0}{I s} ) \qquad ( 4 )$$

a ratio of A*DVbe to the VREF voltage is converted by the Sigma-Delta ADC to acquire the digital temperature Dout, as shown in Eq. (5):

$$Dout = k 1 * \frac{A * D v b e}{A * D v b e + V b e p} - k 2 = k 1 * \frac{A * D v b e}{V R E F} - k 2 \qquad ( 5 )$$

where, A denotes a ratio factor implemented in an analog domain; K denotes a Boltzmann constant; T denotes a temperature; q denotes a charge of a single electron; Is denotes a saturation current of the transistor; and k1 and k2 denote a slope and a deviation value of a temperature converter, respectively.

Preferably, a fully differential Sigma-Delta ADC is used; in an initial state, a signal 0 is input at two ends of the OTA, with a common mode voltage of Vcm; at the time, a result of the CMP is not counted into the digital domain; when a first large cycle U arrives, the OTA input is forcibly processed through the switch logic to achieve Vcm−Vbep at a positive end of the OTA and Vcm+Vbep at a negative end of the OTA; at the time, in the T0 cycle, a −Vbep operation is performed; in the digital domain, a value p is counted by a 24 bit register ctrl_vbep[23:0], and a value w is counted by a 24 bit register ctrl_tpq[23:0]; after an OTA integration, the CMP acquires a result of 0, and a feedback is sent to a digital control switch logic to generate a +Dvbe operation; and in the digital domain, a value r is counted by a 24 bit register ctrl_Dvbe[23:0];
therefore, through the switch logic, the positive end and the negative end of the OTA are converted to Vcm−Vbep+Dvbe and Vcm+Vbep−Dvbe, respectively; at the time, if the result of the CMP is still 0, the +Dvbe operation is continued until an x-th cycle when Eq. (6) or (7) is exactly satisfied;

$$Vcm \geq Vcm + V b ep - x * Dvbe \geq V c m - 0.5 * Dvbe \qquad ( 6 )$$

$$Vcm + 0.5 * Dvbe \geq V c m + V b ep - x * Dvbe \geq Vcm \qquad ( 7 )$$

when Eq. (6) is exactly satisfied, T1=2x+1; when Eq. (7) is exactly satisfied, T1=2x−1; the x-th cycle is a cycle closest to a CMP flip, and in the cycle, a signal amplitude is (−0.5Dvbe, 0.5Dvbe); to prevent a loss of accuracy in the Sigma-Delta ADC caused by an incorrect judgment at a time when a small signal amplitude occurs, x needs to be doubled to 2×; thus, a temperature dependent ratio close to vbep/Dvbe is acquired; and a final feedback is output through the digital register, as well as a factor of x.

Preferably, a complete Dvbe and Vbe conversion involves U cycles; if an entire temperature conversion involves a total of v cycles, there are a total of U*v temperature conversion cycles; there are v*T0 vbep conversions, and the value counted by the digital domain register ctrl_vbep[23:0] is p*v, while the value counted by the digital domain register ctrl_tpq[23:0] is w*v; and there are T1*v Dvbe conversions, and the value counted by the digital domain register ctrl_Dvbe[23:0] is r*T1*v, T1=m*T0;
in the digital domain, additional registers k1 and k2 are configured as the slope and the deviation value of the temperature converter, respectively; and finally, an analog quantity Temp corresponding to the digital temperature Dout is acquired, as shown in Eq. (8):

$$Temp = k 1 \frac{w * v}{p * v + r * m * v} - k 2 \qquad ( 8 )$$

by further simplifying, Eq. (9) is acquired:

$$Temp = k 1 \frac{w / r}{p / r + m} - k 2 \qquad ( 9 )$$

assuming k0*w/r−k3*p/r, and substituting k0*w/r=k3*p/r into Eq. (9) leads to Eq. (10):

$$Temp = k 3 \frac{p / r}{p / r + m} - k 2 \qquad ( 10 )$$

thus, a digital domain temperature model is constructed; Eq. (5) is compared, and upper and lower sides of Eq. (5) are divided by Dvbe; and through an adjustment, Eq. (11) is acquired:

$$Dout = k 1 * \frac{A}{A + V b e p / D v b e} - k 2 \qquad ( 11 )$$

Vbep/Dvbe≈m, where m is a value that is infinitely close to Vbep/Dvbe, with an accuracy determined by the total temperature conversion cycles U*v; thus, only p/r-A is required through a register configuration; meanwhile, an optimal slope k1 or k3 for different processes is adjustable according to an optimal temperature curve; and the deviation value k2 is finally determined by a register trim; and
in Eq. (10), due to the fact that the denominator m is a value that is infinitely close to Vbep/Dvbe, the denominator m is a temperature dependent quantity; fitting is performed according to an actual model to acquire a final linear curve, such that u=(A)/(A+m) is positively correlated with temperature; based on m values of different processes, an optimal A value is directly found through a digital domain correction, achieving a curvature to linearity temperature conversion; and meanwhile, by finding the optimal A value by modeling through a function, a temperature conversion curve with a highest linearity is acquired.

In the present disclosure, the circuit optimization system for a digital domain correction of a temperature sensor includes:
a module M1, configured to: subject negative temperature coefficient voltages Vbep and Vben to a switch timing control, thereby generating a corresponding negative temperature coefficient voltage Vbep and positive temperature coefficient voltage Dvbe as inputs into an OTA that serves as a core circuit of a Sigam-Delt ADC; and
a module M2, configured to: generate, by a switch sampling circuit, Vintx by integrating; input the Vintx into a CMP to acquire a final ADC output; and send a feedback through a digital domain to an analog domain control switch logic.

Preferably, Dvbe and a temperature derivative of Dvbe are relatively small, requiring multi-cycle conversions, or one conversion through a high capacitance ratio; and therefore, a T0 cycle is defined as a conversion cycle of Vbe, T0=1, while T1 is defined as a conversion cycle of Dvbe, T1≥1, and T0+T1=U; and
a ratio relationship between Vbe and Dvbe depends on an actual process; a temperature conversion requires U complete cycles to be superimposed to generate VREF; a ratio of Dvbe to Vbep generated through a digital control is equivalent to an OTA input, and an output proportional to Vbep is given to the OTA; and finally, through digital domain processing, an output digital temperature Dout is acquired.

Preferably, a PTAT current I0 is generated through a Bandgap circuit; the PTAT current is mirrored through Mp0 onto Mp1 and Mp2, with a quantitative ratio of Mp0:Mp1:Mp2=1:1:N; and therefore, a three-way current ratio is 1:1:N, and a ratio of currents passing through transistors Q0 and Q1 is 1:N;
based on the quantitative ratio of Q0 and Q1 being 1, the negative temperature coefficient voltages Vbep and Vben are acquired; Vbep is amplified by a switch logic and superimposed with Vben to generate the temperature independent reference voltage VREF, as shown in Eq. (1):

$$VREF = {A}^{*} V bep + Vben \qquad ( 1 )$$

meanwhile, the PTAT voltage DVbe is generated, as shown in Eq. (2):

$$DVbe = Vbep - Vben = \frac{K T}{q} ln ( N ) \qquad ( 2 )$$

where, Vbep and Vben are expressed by Eqs. (3) and (4), respectively:

$$Vbep = \frac{K T}{q} ln ( \frac{N * I 0}{I s} ) \qquad ( 3 )$$

$$Vben = \frac{K T}{q} ln ( \frac{I 0}{I s} ) \qquad ( 4 )$$

a ratio of A*DVbe to the VREF voltage is converted by the Sigma-Delta ADC to acquire the digital temperature Dout, as shown in Eq. (5):

$$Dout = k 1 * \frac{A * D v b e}{A * D v b e + V b e p} - k 2 = k 1 * \frac{A * D v b e}{V R E F} - k 2 \qquad ( 5 )$$

where, A denotes a ratio factor implemented in an analog domain; K denotes a Boltzmann constant; T denotes a temperature; q denotes a charge of a single electron; Is denotes a saturation current of the transistor; and k1 and k2 denote a slope and a deviation value of a temperature converter, respectively.

Preferably, a fully differential Sigma-Delta ADC is used; in an initial state, a signal 0 is input at two ends of the OTA, with a common mode voltage of Vcm; at the time, a result of the CMP is not counted into the digital domain; when a first large cycle U arrives, the OTA input is forcibly processed through the switch logic to achieve Vcm−Vbep at a positive end of the OTA and Vcm+Vbep at a negative end of the OTA; at the time, in the T0 cycle, a −Vbep operation is performed; in the digital domain, a value p is counted by a 24 bit register ctrl_vbep[23:0], and a value w is counted by a 24 bit register ctrl_tpq[23:0]; after an OTA integration, the CMP acquires a result of 0, and a feedback is sent to a digital control switch logic to generate a +Dvbe operation; and in the digital domain, a value r is counted by a 24 bit register ctrl_Dvbe[23:0];

therefore, through the switch logic, the positive end and the negative end of the OTA are converted to Vcm−Vbep+Dvbe and Vcm+Vbep-Dvbe, respectively; at the time, if the result of the CMP is still 0, the +Dvbe operation is continued until an x-th cycle when Eq. (6) or (7) is exactly satisfied;

$$Vcm \geq Vcm + V b ep - x * Dvbe \geq V c m - 0.5 * Dvbe \qquad ( 6 )$$

$$Vcm + 0.5 * Dvbe \geq V c m + V b ep - x * Dvbe \geq Vcm \qquad ( 7 )$$

when Eq. (6) is exactly satisfied, T1=2x+1; when Eq. (7) is exactly satisfied, T1=2x−1; the x-th cycle is a cycle closest to a CMP flip, and in the cycle, a signal amplitude is (−0.5Dvbe, 0.5Dvbe); to prevent a loss of accuracy in the Sigma-Delta ADC caused by an incorrect judgment at a time when a small signal amplitude occurs, x needs to be doubled to 2x; thus, a temperature dependent ratio close to vbep/Dvbe is acquired; and a final feedback is output through the digital register, as well as a factor of x.

Preferably, a complete Dvbe and Vbe conversion involves U cycles; if an entire temperature conversion involves a total of v cycles, there are a total of U*v temperature conversion cycles; there are v*T0 vbep conversions, and the value counted by the digital domain register ctrl_vbep[23:0] is p*v, while the value counted by the digital domain register ctrl_tpq[23:0] is w*v; and there are T1*v Dvbe conversions, and the value counted by the digital domain register ctrl_Dvbe[23:0] is r*T1*v, T1=m*T0;
in the digital domain, additional registers k1 and k2 are configured as the slope and the deviation value of the temperature converter, respectively; and finally, an analog quantity Temp corresponding to the digital temperature Dout is acquired, as shown in Eq. (8):

$$Temp = k 1 \frac{w * v}{p * v + r * m * v} - k 2 \qquad ( 8 )$$

by further simplifying, Eq. (9) is acquired:

$$Temp = k 1 \frac{w / r}{p / r + m} - k 2 \qquad ( 9 )$$

assuming k0*w/r−k3*p/r, and substituting k0*w/r=k3*p/r into Eq. (9) leads to Eq. (10):

$$Temp = k 3 \frac{p / r}{p / r + m} - k 2 \qquad ( 10 )$$

thus, a digital domain temperature model is constructed; Eq. (5) is compared, and upper and lower sides of Eq. (5) are divided by Dvbe; and through an adjustment, Eq. (11) is acquired:

$$Dout = k 1 * \frac{A}{A + Vbep / Dvbe} - k 2 \qquad ( 11 )$$

Vbep/Dvbe≈m, where m is a value that is infinitely close to Vbep/Dvbe, with an accuracy determined by the total temperature conversion cycles U*v; thus, only p/r=A is required through a register configuration; meanwhile, an optimal slope k1 or k3 for different processes is adjustable according to an optimal temperature curve; and the deviation value k2 is finally determined by a register trim; and
in Eq. (10), due to the fact that the denominator m is a value that is infinitely close to Vbep/Dvbe, the denominator m is a temperature dependent quantity; fitting is performed according to an actual model to acquire a final linear curve, such that u=(A)/(A+m) is positively correlated with temperature; based on m values of different processes, an optimal A value is directly found through a digital domain correction, achieving a curvature to linearity temperature conversion; and meanwhile, by finding the optimal A value by modeling through a function, a temperature conversion curve with a highest linearity is acquired.

Compared with the prior art, the present disclosure has the following beneficial effects:

(1) The present disclosure uses a digital domain correction method to achieve an optimal proportion adjustment of a temperature curve completed in an analog domain as well as the integration of a final trim optimization for the product. The present disclosure intelligently finds the optimal temperature factor of different processes through the digital domain correction, thereby acquiring the desired ratio value more accurately. Meanwhile, the present disclosure reduces the trim circuit to be implemented in the analog domain, greatly saving the area of the analog layout and improving the temperature conversion accuracy of the chip.

(2) The implementation principle of the method of the present disclosure is as follows. The present disclosure implements the temperature conversion in the original traditional analog domain and directly fully processes the correction principle implemented in the analog part based on the digital output. The present disclosure is more accurate, convenient, and intelligent. Meanwhile, the present disclosure simplifies the principle of temperature conversion and eliminates the need for artificially constructing the temperature independent reference voltage. The present disclosure can quickly scan the desired parameter curvature change factor A through software aid while prioritizing the temperature characteristics of the process transistor, and ultimately acquire the optimal temperature conversion curve.

(3) The present disclosure has high process compatibility, and can quickly adapt to different manufacturing processes by manually modifying a few register values, thereby adapting to more high-accuracy applications.

### BRIEF DESCRIPTION OF THE DRAWINGS

Other features, objectives, and advantages of the present disclosure will become more apparent by reading the detailed description of non-limiting embodiments with reference to the following drawings.

FIG. 1 is a schematic circuit diagram of a traditional temperature sensor;

FIG. 2 is a schematic circuit diagram of a temperature sensor according to the present disclosure;

FIG. 3 is a schematic circuit diagram of the temperature sensor according to the present disclosure;

FIG. 4 is a coefficient optimization timing diagram of the temperature sensor according to the present disclosure; and

FIG. 5 is a schematic optimization diagram of the temperature sensor according to the present disclosure.

### DETAILED DESCRIPTION OF THE EMBODIMENTS

The present disclosure is described in detail below with reference to specific embodiments. The following embodiments will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

### Embodiment 1

The present disclosure provides a circuit optimization method for a digital domain correction of a temperature sensor.

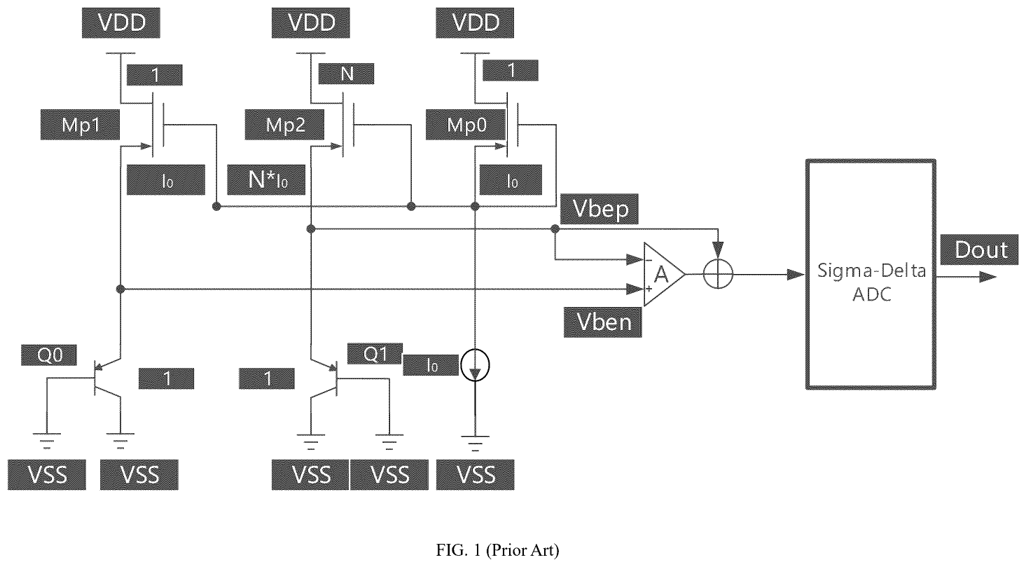

FIG. 1 is a schematic circuit diagram of a common temperature sensor. PTAT current I0 is generated through a Bandgap circuit, and the PTAT current is mirrored through Mp0 onto Mp1 and Mp2, with a quantitative ratio of Mp0:Mp1:Mp2=1:1:N. Therefore, a three-way current ratio is 1:1:N, and a ratio of currents passing through transistors Q0 and Q1 is 1:N. Based on the quantitative ratio of Q0 and Q1 being 1, negative temperature coefficient voltages Vbep and Vben are acquired. Vbep is amplified by A and superimposed with Vben to generate temperature independent reference voltage VREF, as shown in Eq. (1). Meanwhile, PTAT voltage DVbe is generated, as shown in Eq. (2). A denotes a ratio factor implemented in an analog domain. Vbep and Vben can be acquired separately, as shown in Eqs. (3) and (4), respectively. K denotes a Boltzmann constant; T denotes a temperature; q denotes a charge of a single electron; and Is denotes a saturation current of the transistor. A ratio of A*DVbe to a VREF voltage is converted by a Sigma-Delta ADC to acquire digital temperature Dout, as shown in Eq. (5). k1 and k2 are Boltzmann constants, k1≈600, and k2≈273.

$$VREF = A * Vbep + Vben \qquad ( 1 )$$

$$DVbe = Vbep - Vben = \frac{KT}{q} ln ( N ) \qquad ( 2 )$$

$$Vbep = \frac{KT}{q} ln ( \frac{N * I 0}{Is} ) \qquad ( 3 )$$

$$Vbem = \frac{KT}{q} ln ( \frac{I 0}{Is} ) \qquad ( 4 )$$

$$Dout = k 1 * \frac{A * D v b e}{A * D v be + Vbep} - k 2 = k 1 * \frac{A * D v b e}{VREF} - k 2 \qquad ( 5 )$$

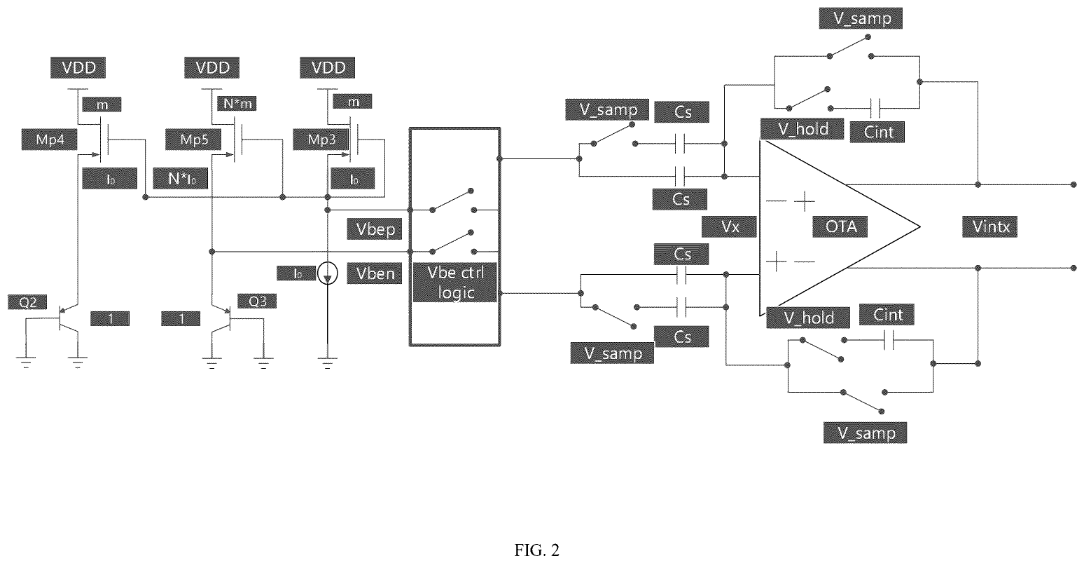

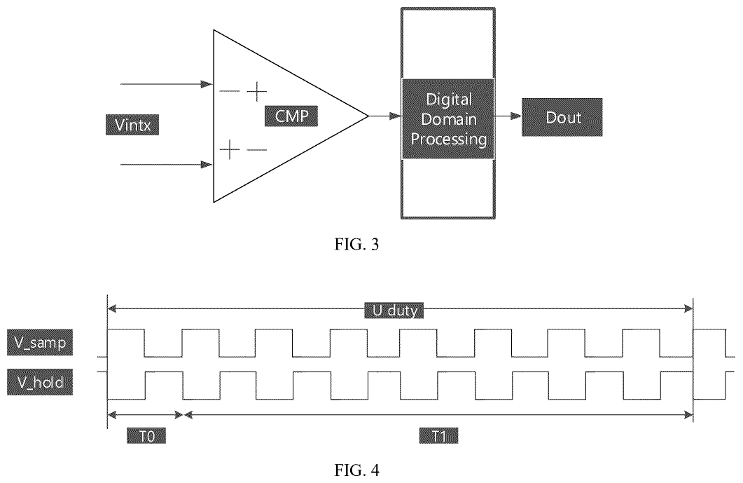

FIGS. 2 and 3 are schematic circuit diagrams of a circuit optimization technique for a digital domain correction of a temperature sensor according to the present disclosure. First, Vbep and Vben are subjected to a certain switch timing control to generate corresponding negative temperature coefficient voltage Vbep and positive temperature coefficient voltage Dvbe as inputs into an OTA, which serves as a core circuit of a Sigam-Delt ADC. A switch sampling circuit generates Vintx by integrating through a timing work shown in FIG. 4. Vintx is input into a CMP to acquire a final ADC output. A feedback is sent through a digital domain to an analog domain control switch logic. Therefore, in multiple cycles, a large area of trim is needed to achieve a high-accuracy method so as to reduce the analog domain. For an 8 bit accuracy capacitance ratio, an 8 bit capacitor is required to achieve accuracy adjustment, thereby greatly increasing the layout area. In a technique of using only 1 times of capacitance ratio, A times is implemented in the digital domain. The digital domain can generate multiple decimal values at a low cost to achieve a high-accuracy ratio, and there will be no imbalance problem in the digital part like in the analog part. Register values can be adjusted to achieve an accurate ratio. Finally, a better temperature characteristic curve can be acquired by adjusting. In a practical operation, digital domain optimization is more convenient and intelligent than analog domain optimization.

A specific operation method in the digital domain is as follows. As shown in FIG. 4, U duty represents a complete conversion cycle of Vbe and voltage Dvbe. Generally, Dvbe and a temperature derivative of Dvbe are relatively small, requiring multi-cycle conversions, or one conversion through a high capacitance ratio. Therefore, a T0 cycle is defined as a conversion cycle of Vbe, T0=1, while T1 is defined as a conversion cycle of Dvbe, T1≥1. T0+T1=U, and a ratio relationship between Vbe and Dvbe depends on an actual process. Generally, a temperature conversion requires U complete cycles to be superimposed to generate VREF. A ratio of Dvbe to Vbep generated through a digital control is equivalent to an OTA input, and an output proportional to Vbep is given to the OTA. Finally, through digital domain processing, an output digital temperature Dout is acquired.

A fully differential Sigma-Delta ADC is used, and in an initial state, a signal 0 is input at two ends of the OTA, with a common mode voltage of Vcm. At the time, a result of the CMP is not counted into the digital domain. When a first large cycle U arrives, the OTA input is forcibly processed through the switch logic to achieve Vom−Vbep at a positive end of the OTA and Vcm+Vbep at a negative end of the OTA. At the time, in the T0 cycle, a −Vbep operation is performed; in the digital domain, a value p is counted by a 24 bit register ctrl_vbep[23:0], and a value w is counted by a 24 bit register ctrl_tpq[23:0]. After an OTA integration, the CMP acquires a result of 0, and a feedback is sent to a digital control switch logic to generate a +Dvbe operation. In the digital domain, a value r is counted by a 24 bit register ctrl_Dvbe[23:0]. Therefore, through the switch logic, the positive end and the negative end of the OTA are converted to Vcm−Vbep+Dvbe and Vcm+Vbep−Dvbe, respectively. At the time, if the result of the CMP is still 0, the +Dvbe operation is continued until an x-th cycle when Eq. (6) or (7) is exactly satisfied. When Eq. (6) is exactly satisfied, T1=2x+1. When Eq. (7) is exactly satisfied, T1=2x−1. The x-th cycle is a cycle closest to a CMP flip, and in the cycle, a signal amplitude is (−0.5Dvbe, 0.5Dvbe). To prevent a loss of accuracy in the Sigma-Delta ADC caused by an incorrect judgment at a time when a small signal amplitude occurs, x needs to be doubled to 2x. Thus, a temperature dependent ratio close to vbep/Dvbe is acquired, and a final feedback is output through the digital register, as well as a factor of x.

A complete Dvbe and Vbe conversion involves U cycles. If an entire temperature conversion involves a total of v cycles, there are a total of U*v temperature conversion cycles. There are v*T0 vbep conversions, and the value counted by the digital domain register ctrl_vbep[23:0] is p*v, while the value counted by the digital domain register ctrl_tpq[23:0] is w*v. There are T1*v Dvbe conversions, and the value counted by the digital domain register ctrl_Dvbe[23:0] is r*T1*v, T1=m*T0 U. Each cycle U is variable, so m may be a decimal. In the digital domain, additional registers k1 and k2 are configured as the slope and the deviation value of the temperature converter, respectively. Finally, an analog quantity Temp corresponding to the digital temperature Dout is acquired, as shown in Eq. (8).

By further simplifying, Eq. (9) is acquired. Assume k0*w/r−k3*p/r, and substituting k0*w/r−k3*p/r into Eq. (9) leads to Eq. (10). Thus, a digital domain temperature model is constructed. Eq. (5) is compared, and upper and lower sides of Eq. (5) are divided by Dvbe. Through an adjustment, Eq. (11) is acquired. Vbep/Dvbe≈m, where m is a value that is infinitely close to Vbep/Dvbe, with an accuracy determined by the total temperature conversion cycles U*v. Thus, only p/r-A is required through a register configuration. Meanwhile, an optimal slope k1 or k3 for different processes is adjustable according to an optimal temperature curve, and the deviation value k2 can finally be determined by a register trim.

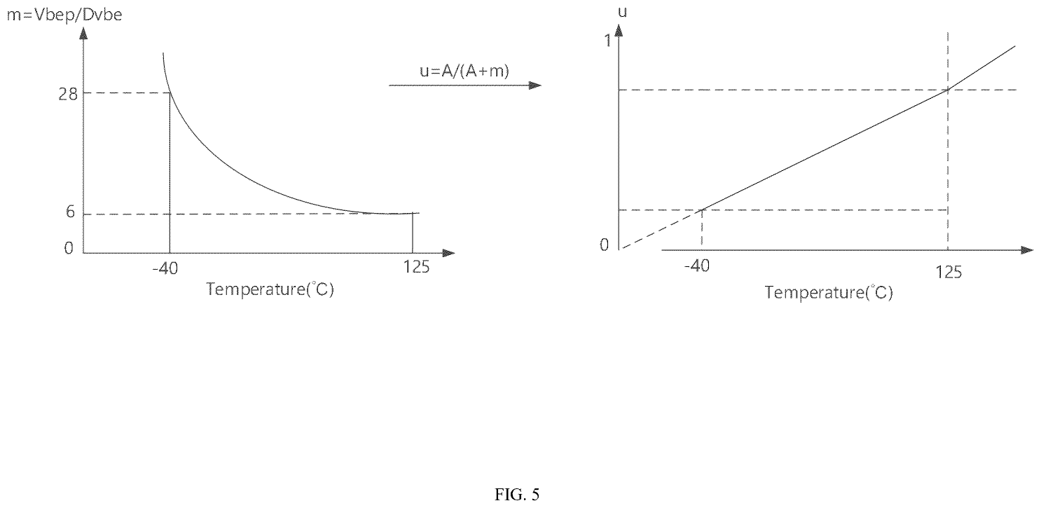

In Eq. (10), the denominator m is a value that is infinitely close to Vbep/Dvbe. Therefore, the value is determined as a temperature dependent quantity. Fitting is performed according to an actual model to acquire a final linear curve, such that u=(A)/(A+m) is positively correlated with temperature, as shown in FIG. 5.

There is no need to construct a temperature independent VREF voltage separately in the analog domain. Based on m values of different processes, an optimal A value is directly found through a digital domain correction, achieving a curvature to linearity temperature conversion. In terms of principle, a portion of the construction of the reference voltage is reduced. Meanwhile, in terms of implementation, by finding the optimal A value by modeling through a function, a temperature conversion curve with a highest linearity is acquired through a software aid.

$$Vcm \geq Vcm + Vbep - x * Dvbe \geq Vcm - 0.5 * Dvbe \qquad ( 6 )$$

$$Vcm + 0.5 * Dvbe \geq Vcm + Vbep - x * Dvbe \geq Vcm \qquad ( 7 )$$

$$Temp = k 1 \frac{w * v}{p * v + r * m * v} - k 2 \qquad ( 8 )$$

$$Temp = k 1 \frac{w / r}{p / r + m} - k 2 \qquad ( 9 )$$

$$Temp = k 3 \frac{p / r}{p / r + m} - k 2 \qquad ( 10 )$$

$$Dout = k 1 * \frac{A}{A + Vbep / Dvbe} - k 2 \qquad ( 11 )$$

Definitions: NMOS: N-type field-effect transistor (Mn); PMOS: P-type field-effect transistor (Mp); PTAT: proportional to absolute temperature; ADC: analog-to-digital converter; and OTA: operational transconductance amplifier.

### Embodiment 2

The present disclosure further provides a circuit optimization system for a digital domain correction of a temperature sensor. The circuit optimization system for a digital domain correction of a temperature sensor can be implemented by executing the process steps of the circuit optimization method for a digital domain correction of a temperature sensor. That is, those skilled in the art can deem the circuit optimization method for a digital domain correction of a temperature sensor as a preferred implementation of the circuit optimization system for a digital domain correction of a temperature sensor.

In the present disclosure, the circuit optimization system for a digital domain correction of a temperature sensor includes:
a module M1, configured to: subject negative temperature coefficient voltages Vbep and Vben to a switch timing control, thereby generating a corresponding negative temperature coefficient voltage Vbep and positive temperature coefficient voltage Dvbe as inputs into an OTA that serves as a core circuit of a Sigam-Delt analog-to-digital converter (ADC); and
a module M2, configured to: generate, by a switch sampling circuit, Vintx by integrating; input the Vintx into a CMP to acquire a final ADC output; and send a feedback through a digital domain to an analog domain control switch logic.

Preferably, Dvbe and a temperature derivative of Dvbe are relatively small, requiring multi-cycle conversions, or one conversion through a high capacitance ratio; and therefore, a T0 cycle is defined as a conversion cycle of Vbe, T0=1, while T1 is defined as a conversion cycle of Dvbe, T1≥1, and T0+T1=U; and a ratio relationship between Vbe and Dvbe depends on an actual process; a temperature conversion requires U complete cycles to be superimposed to generate VREF; a ratio of Dvbe to Vbep generated through a digital control is equivalent to an OTA input, and an output proportional to Vbep is given to the OTA; and finally, through digital domain processing, an output digital temperature Dout is acquired.

Preferably, a PTAT current I0 is generated through a Bandgap circuit; the PTAT current is mirrored through Mp0 onto Mp1 and Mp2, with a quantitative ratio of Mp0:Mp1:Mp2=1:1:N; and therefore, a three-way current ratio is 1:1:N, and a ratio of currents passing through transistors Q0 and Q1 is 1:N;
based on the quantitative ratio of Q0 and Q1 being 1, the negative temperature coefficient voltages Vbep and Vben are acquired; Vbep is amplified by a switch logic and superimposed with Vben to generate the temperature independent reference voltage VREF, as shown in Eq. (1):

$$VREF = A * Vbep + Vben \qquad ( 1 )$$

meanwhile, the PTAT voltage DVbe is generated, as shown in Eq. (2):

$$DVbe = Vbep - Vben = \frac{KT}{q} ln ( N ) \qquad ( 2 )$$

where, Vbep and Vben are expressed by Eqs. (3) and (4), respectively:

$$Vbep = \frac{KT}{q} ln ( \frac{N * I 0}{Is} ) \qquad ( 3 )$$

$$Vbem = \frac{KT}{q} ln ( \frac{I 0}{Is} ) \qquad ( 4 )$$

a ratio of A*DVbe to the VREF voltage is converted by the Sigma-Delta ADC to acquire the digital temperature Dout, as shown in Eq. (5):

$$Dout = k 1 * \frac{A * D v b e}{A * D v be + Vbep} - k 2 = k 1 * \frac{A * D v b e}{VREF} - k 2 \qquad ( 5 )$$

where, A denotes a ratio factor implemented in an analog domain; K denotes a Boltzmann constant; T denotes a temperature; q denotes a charge of a single electron; Is denotes a saturation current of the transistor; and k1 and k2 denote a slope and a deviation value of a temperature converter, respectively.

Preferably, a fully differential Sigma-Delta ADC is used; in an initial state, a signal 0 is input at two ends of the OTA, with a common mode voltage of Vcm; at the time, a result of the CMP is not counted into the digital domain; when a first large cycle U arrives, the OTA input is forcibly processed through the switch logic to achieve Vcm−Vbep at a positive end of the OTA and Vcm+Vbep at a negative end of the OTA; at the time, in the T0 cycle, a −Vbep operation is performed; in the digital domain, a value p is counted by a 24 bit register ctrl_vbep[23:0], and a value w is counted by a 24 bit register ctrl_tpq[23:0]; after an OTA integration, the CMP acquires a result of 0, and a feedback is sent to a digital control switch logic to generate a +Dvbe operation; and in the digital domain, a value r is counted by a 24 bit register ctrl_Dvbe[23:0];
therefore, through the switch logic, the positive end and the negative end of the OTA are converted to Vcm−Vbep+Dvbe and Vcm+Vbep-Dvbe, respectively; at the time, if the result of the CMP is still 0, the +Dvbe operation is continued until an x-th cycle when Eq. (6) or (7) is exactly satisfied;

$$Vcm \geq Vcm + Vbep - x * Dvbe \geq Vcm - 0.5 * Dvbe \qquad ( 6 )$$

$$Vcm + 0.5 * Dvbe \geq Vcm + Vbep - x * Dvbe \geq Vcm \qquad ( 7 )$$

when Eq. (6) is exactly satisfied, T1−2x+1; when Eq. (7) is exactly satisfied, T1=2x−1; the x-th cycle is a cycle closest to a CMP flip, and in the cycle, a signal amplitude is (−0.5Dvbe, 0.5Dvbe); to prevent a loss of accuracy in the Sigma-Delta ADC caused by an incorrect judgment at a time when a small signal amplitude occurs, x needs to be doubled to 2x; thus, a temperature dependent ratio close to vbep/Dvbe is acquired; and a final feedback is output through the digital register, as well as a factor of x.

Preferably, a complete Dvbe and Vbe conversion involves U cycles; if an entire temperature conversion involves a total of v cycles, there are a total of U*v temperature conversion cycles; there are v*T0 vbep conversions, and the value counted by the digital domain register ctrl_vbep[23:0] is p*v, while the value counted by the digital domain register ctrl_tpq[23:0] is w*v; and there are T1*v Dvbe conversions, and the value counted by the digital domain register ctrl_Dvbe[23:0] is r*T1*v, T1=m*T0;
in the digital domain, additional registers k1 and k2 are configured as the slope and the deviation value of the temperature converter, respectively; and finally, an analog quantity Temp corresponding to the digital temperature Dout is acquired, as shown in Eq. (8):

$$Temp = k 1 \frac{w * v}{p * v + r * m * v} - k 2 \qquad ( 8 )$$

by further simplifying, Eq. (9) is acquired:

$$Temp = k 1 \frac{w / r}{p / r + m} - k 2 \qquad ( 9 )$$

assuming k0*w/r−k3*p/r, and substituting k0*w/r=k3*p/r into Eq. (9) leads to Eq. (10):

$$Temp = k 3 \frac{p / r}{p / r + m} - k 2 \qquad ( 10 )$$

thus, a digital domain temperature model is constructed; Eq. (5) is compared, and upper and lower sides of Eq. (5) are divided by Dvbe; and through an adjustment, Eq. (11) is acquired:

$$Dout = k 1 * \frac{A}{A + Vbep / Dvbe} - k 2 \qquad ( 11 )$$

Vbep/Dvbe≈m, where m is a value that is infinitely close to Vbep/Dvbe, with an accuracy determined by the total temperature conversion cycles U*v; thus, only p/r=A is required through a register configuration; meanwhile, an optimal slope k1 or k3 for different processes is adjustable according to an optimal temperature curve; and the deviation value k2 is finally determined by a register trim; and
in Eq. (10), due to the fact that the denominator m is a value that is infinitely close to Vbep/Dvbe, the denominator m is a temperature dependent quantity; fitting is performed according to an actual model to acquire a final linear curve, such that u=(A)/(A+m) is positively correlated with temperature; based on m values of different processes, an optimal A value is directly found through a digital domain correction, achieving a curvature to linearity temperature conversion; and meanwhile, by finding the optimal A value by modeling through a function, a temperature conversion curve with a highest linearity is acquired.

In the description of the present application, it needs to be understood the orientation or positional relationships indicated by terms, such as “up”, “down”, “front”, “rear”, “left”, “right”, “vertical”, “horizontal”, “top”, “bottom”, “inside”, and “outside”, are based on the orientation or positional relationship shown in the drawings, are merely for facilitating the description of the present application and simplifying the description, rather than indicating or implying that an apparatus or element referred to must have a particular orientation or be constructed and operated in a particular orientation, and therefore shall not be interpreted as limiting the present application.

Those skilled in the art are aware that in addition to being realized by using pure computer-readable program code, the system, the apparatus, and each module thereof provided in the present disclosure can realize a same program in a form of a logic gate, a switch, an application-specific integrated circuit, a programmable logic controller, or an embedded microcontroller by performing logic programming on the method steps. Therefore, the system, the apparatus, and each module thereof provided in the present disclosure can be regarded as a kind of hardware component. The module included therein for realizing each program can also be regarded as a structure in the hardware component; and the module for realizing each function can also be regarded as a software program for implementing the method or a structure in the hardware component.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments of the present disclosure and features in the embodiments may be arbitrarily combined with each other in a non-conflicting situation.

What is claimed is:

1. A circuit optimization method for a digital domain correction of a temperature sensor, comprising:
step 1: subjecting negative temperature coefficient voltages Vbep and Vben to a switch timing control, thereby generating a corresponding negative temperature coefficient voltage Vbep and positive temperature coefficient voltage Dvbe as inputs into an operational transconductance amplifier (OTA) that serves as a core circuit of a Sigam-Delt analog-to-digital converter (ADC); and
step 2: generating, by a switch sampling circuit, Vintx by integrating; inputting the Vintx into a comparator (CMP) to acquire a final ADC output; and sending a feedback through a digital domain to an analog domain control switch logic.

2. The circuit optimization method for the digital domain correction of the temperature sensor according to claim 1, wherein Dvbe and a temperature derivative of Dvbe are relatively small, requiring multi-cycle conversions, or one conversion through a high capacitance ratio; and therefore, a T0 cycle is defined as a conversion cycle of Vbe, T0=1, while T1 is defined as a conversion cycle of Dvbe, T1≥1, and T0+T1=U; and
a ratio relationship between Vbe and Dvbe depends on an actual process; a temperature conversion requires U complete cycles to be superimposed to generate VREF; a ratio of Dvbe to Vbep generated through a digital control is equivalent to an OTA input, and an output proportional to Vbep is given to the OTA; and finally, through digital domain processing, an output digital temperature Dout is acquired.

3. The circuit optimization method for the digital domain correction of the temperature sensor according to claim 2, wherein a proportional to absolute temperature (PTAT) current I0 is generated through a Bandgap circuit; the PTAT current is mirrored through Mp0 onto Mp1 and Mp2, with a quantitative ratio of Mp0:Mp1:Mp2=1:1:N; and therefore, a three-way current ratio is 1:1:N, and a ratio of currents passing through transistors Q0 and Q1 is 1: N;
based on the quantitative ratio of Q0 and Q1 being 1, the negative temperature coefficient voltages Vbep and Vben are acquired; Vbep is amplified by a switch logic and superimposed with Vben to generate the temperature independent reference voltage VREF, as shown in Eq. (1):
$$VREF = A * Vbep + Vben \qquad ( 1 )$$
meanwhile, the PTAT voltage DVbe is generated, as shown in Eq. (2):
$$DVbe = Vbep - Vben = \frac{KT}{q} ln ( N ) \qquad ( 2 )$$
wherein Vbep and Vben are expressed by Eqs. (3) and (4), respectively:
$$Vbep = \frac{KT}{q} ln ( \frac{N * I 0}{Is} ) \qquad ( 3 )$$
$$Vbem = \frac{KT}{q} ln ( \frac{I 0}{Is} ) \qquad ( 4 )$$
a ratio of A*DVbe to the VREF voltage is converted by the Sigma-Delta ADC to acquire the digital temperature Dout, as shown in Eq. (5):
$$Dout = k 1 * \frac{A * D v b e}{A * D v b e + V b e p} - k 2 = k 1 * \frac{A * D v b e}{V R E F} - k 2 \qquad ( 5 )$$
wherein A denotes a ratio factor implemented in an analog domain; K denotes a Boltzmann constant; T denotes a temperature; q denotes a charge of a single electron; Is denotes a saturation current of the transistor; and k1 and k2 denote a slope and a deviation value of a temperature converter, respectively.

4. The circuit optimization method for the digital domain correction of the temperature sensor according to claim 3, wherein a fully differential Sigma-Delta ADC is used; in an initial state, a signal 0 is input at two ends of the OTA, with a common mode voltage of Vcm; at the time, a result of the CMP is not counted into the digital domain; when a first large cycle U arrives, the OTA input is forcibly processed through the switch logic to achieve Vcm−Vbep at a positive end of the OTA and Vcm+Vbep at a negative end of the OTA; at the time, in the T0 cycle, a −Vbep operation is performed; in the digital domain, a value p is counted by a 24 bit register ctrl_vbep[23:0], and a value w is counted by a 24 bit register ctrl_tpq[23:0];
after an OTA integration, the CMP acquires a result of 0, and a feedback is sent to a digital control switch logic to generate a +Dvbe operation; and in the digital domain, a value r is counted by a 24 bit register ctrl_Dvbe[23:0];
therefore, through the switch logic, the positive end and the negative end of the OTA are converted to Vcm−Vbep+Dvbe and Vcm+Vbep−Dvbe, respectively; at the time, if the result of the CMP is still 0, the +Dvbe operation is continued until an x-th cycle when Eq. (6) or (7) is exactly satisfied;
$$Vcm \geq Vcm + Vbep - x * Dvbe \geq Vcm - 0.5 * Dvbe \qquad ( 6 )$$
$$Vcm + 0.5 * Dvbe \geq V c m + V b ep - x * Dvbe \geq Vcm \qquad ( 7 )$$
when Eq. (6) is exactly satisfied, T1=2x+1; when Eq. (7) is exactly satisfied, T1=2x−1; the x-th cycle is a cycle closest to a CMP flip, and in the x-th cycle, a signal amplitude is (−0.5Dvbe, 0.5Dvbe); to prevent a loss of accuracy in the Sigma-Delta ADC caused by an incorrect judgment at a time when a small signal amplitude occurs, x needs to be doubled to 2x; thus, a temperature dependent ratio close to vbep/Dvbe is acquired; and a final feedback is output through the digital register, as well as a factor of x.

5. The circuit optimization method for the digital domain correction of the temperature sensor according to claim 4, wherein a complete Dvbe and Vbe conversion involves U cycles; if an entire temperature conversion involves a total of v cycles, there are a total of U*v temperature conversion cycles; there are v*T0 vbep conversions, and the value counted by the digital domain register ctrl_vbep[23:0] is p*v, while the value counted by the digital domain register ctrl_tpq[23:0] is w*v; and there are T1*v Dvbe conversions, and the value counted by the digital domain register ctrl_Dvbe[23:0] is r*T1*v, T1=m*T0;
in the digital domain, additional registers k1 and k2 are configured as the slope and the deviation value of the temperature converter, respectively; and finally, an analog quantity Temp corresponding to the digital temperature Dout is acquired, as shown in Eq. (8):
$$Temp = k 1 \frac{w * v}{p * v + r * m * v} - k 2 \qquad ( 8 )$$
by further simplifying, Eq. (9) is acquired:
$$Temp = k 1 \frac{w / r}{p / r + m} - k 2 \qquad ( 9 )$$
assuming k0*w/r=k3*p/r, and substituting k0*w/r=k3*p/r into Eq. (9) leads to Eq. (10):
$$Temp = k 3 \frac{p / r}{p / r + m} - k 2 \qquad ( 10 )$$
thus, a digital domain temperature model is constructed; Eq. (5) is compared, and upper and lower sides of Eq. (5) are divided by Dvbe; and through an adjustment, Eq. (11) is acquired:
$$Dout = k 1 * \frac{A}{A + V bep / Dvbe} - k 2 \qquad ( 11 )$$
Vbep/Dvbe≈m, wherein m is a value that is infinitely close to Vbep/Dvbe, with an accuracy determined by the total temperature conversion cycles U*v; thus, only p/r=A is required through a register configuration; meanwhile, an optimal slope k1 or k3 for different processes is adjustable according to an optimal temperature curve; and the deviation value k2 is finally determined by a register trim; and
in Eq. (10), due to the fact that the denominator m is a value that is infinitely close to Vbep/Dvbe, the denominator m is a temperature dependent quantity; fitting is performed according to an actual model to acquire a final linear curve, such that u=(A)/(A+m) is positively correlated with temperature; based on m values of different processes, an optimal A value is directly found through a digital domain correction, achieving a curvature to linearity temperature conversion; and meanwhile, by finding the optimal A value by modeling through a function, a temperature conversion curve with a highest linearity is acquired.

6. A circuit optimization system for a digital domain correction of a temperature sensor, comprising:
a first module, configured to: subject negative temperature coefficient voltages Vbep and Vben to a switch timing control, thereby generating a corresponding negative temperature coefficient voltage Vbep and positive temperature coefficient voltage Dvbe as inputs into an OTA that serves as a core circuit of a Sigam-Delt ADC; and
a second module, configured to: generate, by a switch sampling circuit, Vintx by integrating; input the Vintx into a CMP to acquire a final ADC output; and send a feedback through a digital domain to an analog domain control switch logic.

7. The circuit optimization system for the digital domain correction of the temperature sensor according to claim 6, wherein Dvbe and a temperature derivative of Dvbe are relatively small, requiring multi-cycle conversions, or one conversion through a high capacitance ratio; and therefore, a T0 cycle is defined as a conversion cycle of Vbe, T0=1, while T1 is defined as a conversion cycle of Dvbe, T1≥1, and T0+T1=U; and
a ratio relationship between Vbe and Dvbe depends on an actual process; a temperature conversion requires U complete cycles to be superimposed to generate VREF; a ratio of Dvbe to Vbep generated through a digital control is equivalent to an OTA input, and an output proportional to Vbep is given to the OTA; and finally, through digital domain processing, an output digital temperature Dout is acquired.

8. The circuit optimization system for the digital domain correction of the temperature sensor according to claim 7, wherein a PTAT current I0 is generated through a Bandgap circuit; the PTAT current is mirrored through Mp0 onto Mp1 and Mp2, with a quantitative ratio of Mp0:Mp1:Mp2=1:1:N; and therefore, a three-way current ratio is 1:1:N, and a ratio of currents passing through transistors Q0 and Q1 is 1:N;
based on the quantitative ratio of Q0 and Q1 being 1, the negative temperature coefficient voltages Vbep and Vben are acquired; Vbep is amplified by a switch logic and superimposed with Vben to generate the temperature independent reference voltage VREF, as shown in Eq. (1):
$$VREF = A * Vbep + Vben \qquad ( 1 )$$
meanwhile, the PTAT voltage DVbe is generated, as shown in Eq. (2):
$$DVbe = Vbep - Vben = \frac{K T}{q} ln ( N ) \qquad ( 2 )$$
wherein Vbep and Vben are expressed by Eqs. (3) and (4), respectively:
$$Vbep = \frac{K T}{q} ln ( \frac{N * I 0}{I s} ) \qquad ( 3 )$$
$$Vben = \frac{K T}{q} ln ( \frac{I 0}{I s} ) \qquad ( 4 )$$
a ratio of A*DVbe to the VREF voltage is converted by the Sigma-Delta ADC to acquire the digital temperature Dout, as shown in Eq. (5):
$$Dout = k 1 * \frac{A * D v b e}{A * D v b e + Vbep} - k 2 = k 1 * \frac{A * D v b e}{V R E F} - k 2 \qquad ( 5 )$$
wherein A denotes a ratio factor implemented in an analog domain; K denotes a Boltzmann constant; T denotes a temperature; q denotes a charge of a single electron; Is denotes a saturation current of the transistor; and k1 and k2 denote a slope and a deviation value of a temperature converter, respectively.

9. The circuit optimization system for the digital domain correction of the temperature sensor according to claim 8, wherein a fully differential Sigma-Delta ADC is used; in an initial state, a signal 0 is input at two ends of the OTA, with a common mode voltage of Vcm; at the time, a result of the CMP is not counted into the digital domain; when a first large cycle U arrives, the OTA input is forcibly processed through the switch logic to achieve Vcm−Vbep at a positive end of the OTA and Vem+Vbep at a negative end of the OTA; at the time, in the T0 cycle, a −Vbep operation is performed; in the digital domain, a value p is counted by a 24 bit register ctrl_vbep[23:0], and a value w is counted by a 24 bit register ctrl_tpq[23:0]; after an OTA integration, the CMP acquires a result of 0, and a feedback is sent to a digital control switch logic to generate a +Dvbe operation; and in the digital domain, a value r is counted by a 24 bit register ctrl_Dvbe[23:0];
therefore, through the switch logic, the positive end and the negative end of the OTA are converted to Vcm−Vbep+Dvbe and Vcm+Vbep−Dvbe, respectively; at the time, if the result of the CMP is still 0, the +Dvbe operation is continued until an x-th cycle when Eq. (6) or (7) is exactly satisfied;
$$Vcm \geq Vcm + Vbep - x * Dvbe \geq Vcm - 0.5 * Dvbe \qquad ( 6 )$$
$$Vcm + 0.5 * Dvbe \geq V c m + V b ep - x * Dvbe \geq Vcm \qquad ( 7 )$$
when Eq. (6) is exactly satisfied, T1=2x+1; when Eq. (7) is exactly satisfied, T1=2x−1; the x-th cycle is a cycle closest to a CMP flip, and in the x-th cycle, a signal amplitude is (−0.5Dvbe, 0.5Dvbe); to prevent a loss of accuracy in the Sigma-Delta ADC caused by an incorrect judgment at a time when a small signal amplitude occurs, x needs to be doubled to 2x; thus, a temperature dependent ratio close to vbep/Dvbe is acquired; and a final feedback is output through the digital register, as well as a factor of x.

10. The circuit optimization system for the digital domain correction of the temperature sensor according to claim 9, wherein a complete Dvbe and Vbe conversion involves U cycles; if an entire temperature conversion involves a total of v cycles, there are a total of U*v temperature conversion cycles; there are v*T0 vbep conversions, and the value counted by the digital domain register ctrl_vbep[23:0] is p*v, while the value counted by the digital domain register ctrl_tpq[23:0] is w*v; and there are T1*v Dvbe conversions, and the value counted by the digital domain register ctrl_Dvbe[23:0] is r*T1*v, T1=m*T0;
in the digital domain, additional registers k1 and k2 are configured as the slope and the deviation value of the temperature converter, respectively; and finally, an analog quantity Temp corresponding to the digital temperature Dout is acquired, as shown in Eq. (8):
$$Temp = k 1 \frac{w * r}{p * r + m * v} - k 2 \qquad ( 8 )$$
by further simplifying, Eq. (9) is acquired:
$$Temp = k 1 \frac{w / r}{p / r + m} - k 2 \qquad ( 9 )$$
assuming k0*w/r=k3*p/r, and substituting k0*w/r−k3*p/r into Eq. (9) leads to Eq. (10):
$$Temp = k 3 \frac{p / r}{p / r + m} - k 2 \qquad ( 10 )$$
thus, a digital domain temperature model is constructed; Eq. (5) is compared, and upper and lower sides of Eq. (5) are divided by Dvbe; and through an adjustment, Eq. (11) is acquired:
$$Dout = k 1 * \frac{A}{A + V bep / Dvbe} - k 2 \qquad ( 11 )$$
Vbep/Dvbe≈m, wherein m is a value that is infinitely close to Vbep/Dvbe, with an accuracy determined by the total temperature conversion cycles U*v; thus, only p/r=A is required through a register configuration; meanwhile, an optimal slope k1 or k3 for different processes is adjustable according to an optimal temperature curve; and the deviation value k2 is finally determined by a register trim; and
in Eq. (10), due to the fact that the denominator m is a value that is infinitely close to Vbep/Dvbe, the denominator m is a temperature dependent quantity; fitting is performed according to an actual model to acquire a final linear curve, such that u=(A)/(A+m) is positively correlated with temperature; based on m values of different processes, an optimal A value is directly found through a digital domain correction, achieving a curvature to linearity temperature conversion; and meanwhile, by finding the optimal A value by modeling through a function, a temperature conversion curve with a highest linearity is acquired.
